(19) United States
(12) Patent Application Publication
(10) Pub. No.: US 2005/0146871 A1
(43) Pub. Date: Jul. 7, 2005

(54) Magnifying optical device

(75) Inventor: Alfred Schuttinger, Heroldsbach (DE)

Correspondence Address: LERNER AND GREENBERG, PA, P O BOX 2480, HOLLYWOOD, FL, 33022-2480, US

(73) Assignee: A. Schweizer GmbH Optische Fabrik

(21) Appl. No.: 11/057,604

(22) Filed: Feb. 14, 2005

Related U.S. Application Data
(63) Continuation of application No. PCT/DE03/02572, filed on Jul. 31, 2003.

(30) Foreign Application Priority Data
Aug. 14, 2002 (DE) 202 12 490.8

(51) Int. Cl. F21V 5/04

(52) U.S. Cl. 362/235; 362/800; 362/33

(57) ABSTRACT

A magnifying optical device, such as a manual magnifying glass, a stand-up magnifying glass, microscope or the like, contains at least one illuminating element for at least partially illuminating an area which is visible through the magnifying optical device. The illuminating element contains at least one LED whose light falls upon the visible area in a diffused manner. The luminous body of the LED is made of a clear material and a diffuser surface is disposed directly on a surface thereof.

### CROSS-REFERENCE TO RELATED APPLICATION

This is a continuing application, under 35 U.S.C. § 120, of copending international application No. PCT/DE2003/002572, filed Jul. 31, 2003, which designated the United states; this application also claims the priority, under 35 U.S.C. § 119, of German patent application No. 202 12 490.8, filed Aug. 14, 2002; the prior applications are herewith incorporated by reference in their entirety.

### BACKGROUND OF THE INVENTION

### FIELD OF THE INVENTION

The invention relates to a magnifying optical device, in particular in the form of a hand magnifier, base magnifier, a microscope or the like. The magnifying optical device has at least one illuminating element provided for at least partially illuminating the area visible through the magnifying optical device. The illuminating device is intended to contain at least one LED whose light falls diffusely onto the visible area.

Such an apparatus is already known, the light of the LED passing through a separate diffuser surface for the purpose of illuminating the visible area. The positioning of a separate diffuser surface in front of the LED requires an additional outlay on mounting and additional space, and this is disadvantageous because of the progressively smaller contribution margins in the production of hand magnifiers as well as the advancing miniaturization of such units.

Moreover, there are also known from the prior art so-called diffuse LEDs whose glass body is formed as a whole of diffuse material, the result of which is that the luminosity of such LEDs is relatively severely restricted.

### SUMMARY OF THE INVENTION

It is accordingly an object of the invention to provide a magnifying optical device which overcomes the above-mentioned disadvantages of the prior art devices of this general type, that it can be produced efficiently and is of compact construction, and the illuminating device for viewing the visible area has a satisfactory luminosity.

With the foregoing and other objects in view there is provided, in accordance with the invention, a magnifying optical device containing at least one illuminating element for at least partially illuminating an area visible through the magnifying optical device. The illuminating element has at least one LED whose light falls diffusely onto the area. The LED has a luminous element formed of a clear material, a surface, and a diffuser surface disposed directly on the surface.

The object is achieved by virtue of the fact that the luminous element of the LED is formed of clear material, and a diffuse surface is disposed directly on its surface. By unifying the diffuser, on the one hand, and the LED with a clear luminous element, on the other hand, the mounting operation of luminous source and diffuser is limited to a single operation. The optical device is of small construction overall, and the formation of the luminous element of the LED from clear material ensures that the apparatus has a satisfactory luminosity. The luminous element of the LED is intended to be provided in one piece with a diffuser surface, it being possible thereby to eliminate a preceding mounting step for fastening a diffuser surface on an LED luminous element. A diffuser can be provided by roughening the surface of the LED. This eliminates the negative color edge effects or color point effects which are otherwise to be observed in LEDs without a diffuser. Moreover, the entire field of view is illuminated approximately uniformly by surface roughening in the case of relatively large-area magnifiers.

However, it is also possible to apply a diffuse coating to the surface of the LED, or to chemically etch the surface of the LED incipiently or, for example, subject it to a sandblasting operation. Similar effects are also achieved by a fine fluting that is applied to the surface of the LED. Overall, the surface of the LED can also be formed of an opaque material layer in order to attain the diffuser effect, it being possible to apply the surface layer of the LED to the clear LED element by a dip method.

In a development of the invention/innovation, it is also possible for the diffuser to be integrally formed on the head of the LED as a unipartite integral plate. It is also advantageously possible to provide a focusing element between the diffuser plate and the luminous element of the LED.

In order to avoid color edge effects, the LED can also be surrounded by a non-transparent cover of a cylindrical type which ensures that it is only through the diffuser plate that light reaches the area visible through the optical device.

Other features which are considered as characteristic for the invention are set forth in the appended claims.

Although the invention is illustrated and described herein as embodied in a magnifying optical device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of a magnifying optical device in the form of a hand magnifier with a diffuser LED according to the invention;

FIG. 2 is a diagrammatic, sectional view of the LED with a luminous element made from clear material and a roughened surface;

FIG. 3 is a diagrammatic, sectional view of the LED with the luminous element made from the clear material and a diffuser plate integrally formed in one piece; and

FIG. 4 is a diagrammatic, sectional view of the LED with the luminous element made of clear material, a focusing element disposed in one piece and a diffuser plate thereon, the luminous element of the LED being surrounded by a shielding sheath of cylindrical type.

### DESCRIPTION OF THE PREFERRED EMBODIMENTS

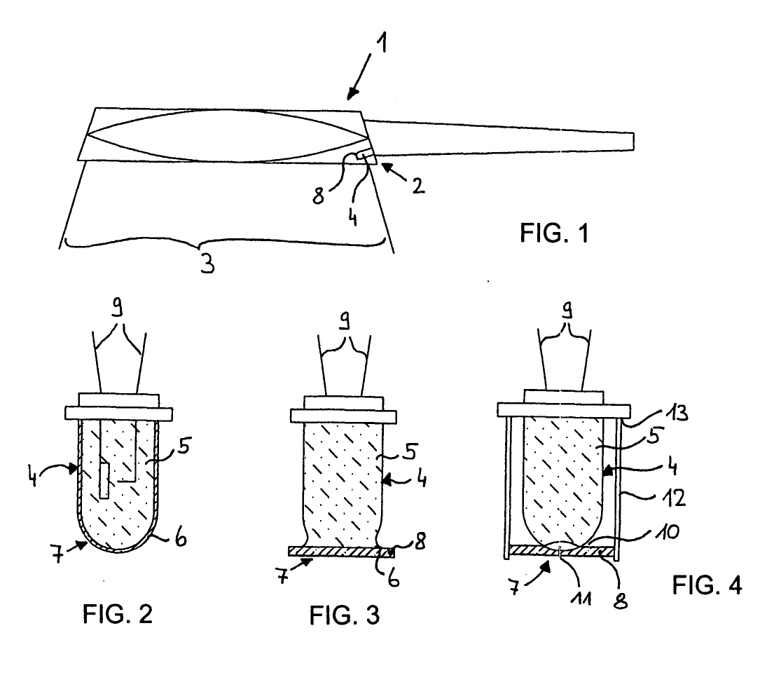

Referring now to the figures of the drawing in detail and first, particularly, to FIG. 1 thereof, there is shown a magnifying optical device 1 in the form of a hand magnifier. The hand magnifier has an illuminating element 2 for at least partially illuminating an area 3 visible through the magnifying optical device 1. The illuminating element 2 contains an LED 4 whose light falls diffusely onto the visible area 3.

Referring to FIG. 2-4, a luminous element 5 of the LED 4 is formed of a clear material on whose surface 6 a diffuser surface 7 is disposed for scattering the light and for avoiding negative color, edge effects. In the exemplary embodiment illustrated in FIGS. 1, 3 and 4, the diffuser surface 7 is a diffuser plate 8 integrally formed or bonded onto the luminous element 5 of the LED 4, the diffuser plate 8 being formed in the case of the exemplary embodiment illustrated in FIG. 2 by roughening of the surface 6 of the luminous element 5 of the LED 4. In a way similar to FIG. 2, however, it is also possible for the surface 6 of the LED 4 to be provided with a diffuse coating 7, with an etching layer or fluting layer or to have the surface be formed of an opaque material.

In the case of the exemplary embodiment illustrated in FIG. 4, a head region 10 of the luminous element 5 averted from terminal connections 9 is provided with a focusing element 11 which for its part bears the diffuser plate 8. It is possible in principle for the focusing element 11 and the diffuser plate 8 to be fabricated as an assembly or even to be of unipartite construction, and then to bond them onto the head region 10 of the luminous element 5 of the LED 4.

Further to be seen in FIG. 4 is a shield 12 of cylindrical type that contains a non-transparent material and surrounds the region of the side wall of the luminous element 5. The shield 12 ensures that light from the luminous element of the LED 4 can fall onto the visible area 3 only through the diffuser plate 8. It is also within the scope of the invention for the diffuser plate 8 to be fastened on an upper edge region 13 of the LED 4 by the shield 12 with or without the focusing element 11.

1. A magnifying optical device, comprising:
at least one illuminating element for at least partially illuminating an area visible through the magnifying optical device, said illuminating element having at least one LED whose light falls diffusely onto said area, said LED having a luminous element formed of a clear material, a surface, and a diffuser surface disposed directly on said surface.

2. The device according to claim 1, wherein said luminous element of said LED is provided in one piece with said diffuser surface.

3. The device according to claim 1, wherein said surface of said LED is roughened for forming said diffuser surface.

4. The device according to claim 1, wherein said diffuser surface is a diffuse coating applied on said surface of said LED.

5. The device according to claim 1, wherein said surface of said LED has an incipiently etched layer forming said diffuser surface.

6. The device according to claim 1, wherein said surface of said LED has a fluting for forming said diffuser surface.

7. The device according to claim 1, wherein said surface of said LED contains an opaque material for forming said diffuser surface.

8. The device according to claim 1, wherein said diffuser surface of said LED is applied to said surface of said luminous element by a dip method.

9. The device according to claim 1, wherein said diffuser surface is a diffuser plate integrally formed or bonded onto said luminous element of said LED.

10. The device according to claim 1, wherein:
said LED has terminal connections; and
said luminous element has a head region, averted from said terminal connections, and a focusing element disposed in said head region.

11. The device according to claim 10, further comprising a diffuser plate functioning as said diffuser surface, and said focusing element bears said diffuser plate.

12. The device according to claim 11, wherein said focusing element and said diffuser plate are of unipartite construction and are fastened on said head region of said luminous element of said LED.

13. The device according to claim 11, wherein:
said luminous element has a side wall; and
said LED has a shield surrounding said luminous element, said shield being of a cylindrical type surrounding a region of said side wall of said luminous element.

14. The device according to claim 13, wherein said shield bears said diffuser plate and/or said focusing element.

15. The device according to claim 1, wherein the magnifying optical device is selected from the group consisting of hand magnifiers, base magnifiers, and microscopes.
